(19) United States
(12) Patent Application Publication
(10) Pub. No.: US 2014/0099454 A1
(43) Pub. Date: Apr. 10, 2014

(54) Hollow Article With Internal Structural Members

(71) Applicants: Raj S. Roychoudhury, Bloomfield Hills, MI (US); Stephen Hawkins, South Lyon, MI (US)

(72) Inventors: Raj S. Roychoudhury, Bloomfield Hills, MI (US); Stephen Hawkins, South Lyon, MI (US)

(73) Assignee: SALFLEX POLYMERS LIMITED, Weston, ON (CA)

(21) Appl. No.: 14/123,574

(22) PCT Filed: Jun. 7, 2012
(86) PCT No.: PCT/US12/41221

§ 371 Date: Dec. 3, 2013

Related U.S. Application Data
(60) Provisional application No. 61/494,252, filed on Jun. 7, 2011.

(51) Int. Cl. B32B 3/22; B29C 49/16

(52) U.S. Cl. CPC B32B 3/22; B29C 49/16
USPC 428/34.1; 264/529

(57) ABSTRACT

A hollow article is provided comprising a first wall, and a second wall, where the first and second walls are positioned in opposing relationship thus defining a space therebetween. A first set of structural members are provided that extend internally from one of the first and second walls, the first set of structural members spanning the space and having an end surface that is integrally bonded with an inside surface of the opposing wall. A second set of structural members is also provided that extend internally from one of the first and second walls, the second set of structural members spanning the space and having an end surface integrally bonded with an inside surface of the opposing wall. The first and second sets of structural members are provided in different orientations.

### CROSS-REFERENCE TO RELATED APPLICATIONS

This application claims benefit under 35 U.S.C. §119(e) to U.S. Provisional Patent Application No. 61/494,252 filed Jun. 7, 2011 and entitled “Structural Load Floor with Criss-Cross Walls,” which is incorporated by reference herein in its entirety.

### FIELD OF THE INVENTION

The present invention relates to hollow articles with internal structural members, and in particular where the structural members are intermittent internal wall segments arranged in multiple possible orientations.

### BACKGROUND OF THE INVENTION

Hollow articles with internal features are generally made using conventional blow molding processes, using molds with fixed protrusions. In these hollow articles, the use of internal ribs (both open and closed) is known, where the internal ribs span the space provided between adjacent wall structures, and create a fused structure therebetween. The internal ribs provide some resistance to part deflection, and are particularly useful in blow molded load bearing parts/structures. For example, internal ribs may be employed in the manufacture of load floors used in automobiles. In a known manufacturing process, an automotive load floor is formed by placing a parison in a mold, and then inflating the parison onto one or more elongated fixed blades to form a hollow article with at least one internal fused rib.

While the use of internal ribs provides some resistance to part deflection, the strength characteristics are directional in nature, that is enhanced strength is generally noted in the direction that is approximately perpendicular to the longitudinal axis of the ribs. Accordingly, improvements are required to make a lighter weight blow molded hollow article with an internal structure that has a higher multi-directional stiffness and thinner section for a given mass than a part made by a conventional blow molding process.

### SUMMARY OF THE INVENTION

According to an aspect of an embodiment, provided is a hollow article comprising a first wall, and a second wall, where the first and second walls are positioned in opposing relationship thus defining a space therebetween. A first set of structural members are provided that extend internally from one of the first and second walls, the first set of structural members spanning the space and having an end surface that is integrally bonded with an inside surface of the opposing wall. A second set of structural members is also provided that extend internally from one of the first and second walls, the second set of structural members spanning the space and having an end surface integrally bonded with an inside surface of the opposing wall. The first and second sets of structural members are provided in different orientations.

According to another aspect of an embodiment, provided is a process for producing a hollow article, the process comprising positioning a parison between a first mold half and a second mold half, the first and second mold half together defining a cavity for forming the hollow article. The first and second mold halves are closed. A first and second set of core blades are extended into the parison, the first set of core blades being arranged in a first orientation, the second set of core blades being arranged in a second orientation, the first and second core blades forming corresponding protrusions in the parison. The protrusions define an end surface that engages and integrally bonds with an opposing inside surface of the parison to form the structural members. Pressurized gas is introduced into the parison so as to cause the parison to bear against the cavity to form the hollow article. The first and second mold half are opened, allowing the hollow article formed therein to be released.

### BRIEF DESCRIPTION OF THE DRAWINGS

The foregoing and other features and advantages of the invention will be apparent from the following description of the invention as illustrated in the accompanying drawings. The accompanying drawings, which are incorporated herein and form a part of the specification, further serve to explain the principles of the invention and to enable a person skilled in the pertinent art to make and use the invention. The drawings are not to scale.

FIG. 1 is a partial sectional perspective view of a hollow article incorporating structural members arranged in two orientations.

FIG. 2 is a cross-sectional plan view of a hollow article according to a first embodiment of the invention.

FIG. 3 is a simplified cross-sectional plan view of the hollow article of FIG. 2.

FIG. 4 is a cross-sectional plan view of a hollow article having a first alternate arrangement of structural members provided therein.

FIG. 5 is a cross-sectional plan view of a hollow article having a second alternate arrangement of structural members provided therein.

FIG. 6 is a cross-sectional plan view of a hollow article having a third alternate arrangement of structural members provided therein.

FIG. 7 is a cross-sectional plan view of a hollow article having a forth alternate arrangement of structural members provided therein.

FIG. 8 is a partial elevation view of a mold tool according to an embodiment hereof showing the arrangement of core blades positioned on opposing sides of the mold tool.

FIG. 9 is a partial elevation view of the mold tool of FIG. 8, showing with a parison during a pre-blow stage of the blow-molding process.

FIG. 10 is a partial sectional view of the mold tool according to FIG. 8 showing initial engagement of the parison by the core blades.

FIG. 11 is a partial sectional view of the mold tool according to FIG. 8 showing the engagement and bonding of the protrusions with the inside surface of the opposing walls on mold closure.

FIG. 12 is a partial sectional view of the mold tool according to FIG. 8 following blow molding of the hollow article.

FIG. 13 is a partial sectional view of the mold tool according to FIG. 8 showing the mold halves separated and the hollow article being released.

FIG. 14a is a partial sectional view of the hollow article wherein the finished structural member is presented on each outside surface as a hollow core.

FIG. 14b is a partial sectional view of the hollow article wherein the finished structural member is presented as a solid core, with no substantial surface feature on each outside surface.

FIG. 14c is a partial sectional view of the hollow article wherein the finished structural member is presented on each outside surface as a hollow indentation.

FIG. 14d is a partial sectional view of the hollow article wherein the finished structural member is presented on each outside surface as a protrusion.

FIG. 15 is a partial perspective view of a core blade according to a first configuration of the edges defining the forward parison-engaging surface.

FIG. 16 is a partial perspective view of a core blade according to a second configuration of the edges defining the forward parison-engaging surface.

FIG. 17 is a partial perspective view of a core blade according to a third configuration of the edges defining the forward parison-engaging surface.

FIG. 18 is a partial perspective view of a core blade according to a forth configuration of the edges defining the forward parison-engaging surface.

FIG. 19 is a partial perspective view of a core blade according to a fifth configuration of the edges defining the forward parison-engaging surface.

FIG. 20 is a partial elevation view of a mold tool according to an embodiment hereof showing the arrangement of core blades positioned on the same side of the mold tool.

FIG. 21 is a partial sectional view of a mold tool according to another embodiment, showing initial engagement of the parison by the core blades.

FIG. 22 is a partial sectional view of the mold tool according to FIG. 19 showing the engagement and bonding of the protrusions with protrusions formed by fixed mold features provided on the inside surface of the opposing walls.

FIG. 23 is a partial sectional view of the mold tool according to FIG. 19 following blow molding of the hollow article.

FIG. 24 is a cross-sectional plan view of a hollow article having a further alternate arrangement of structural members provided therein.

### DETAILED DESCRIPTION OF EMBODIMENTS OF THE PRESENT INVENTION

Specific embodiments of the present invention will now be described with reference to the Figures, wherein like reference numbers indicate identical or functionally similar elements. The following detailed description is merely exemplary in nature and is not intended to limit the invention or the application and uses of the invention. A person skilled in the relevant art will recognize that other configurations and arrangements can be used without departing from the scope of the invention. Although the description and drawings of the embodiments hereof exemplify the formation/use of structural members in a load-floor application, the invention may also be used in other applications, such as automotive seat-backs and other hollow load-bearing structural components. Furthermore, there is no intention to be bound by any expressed or implied theory presented in the preceding technical field, background, brief summary or the following detailed description.

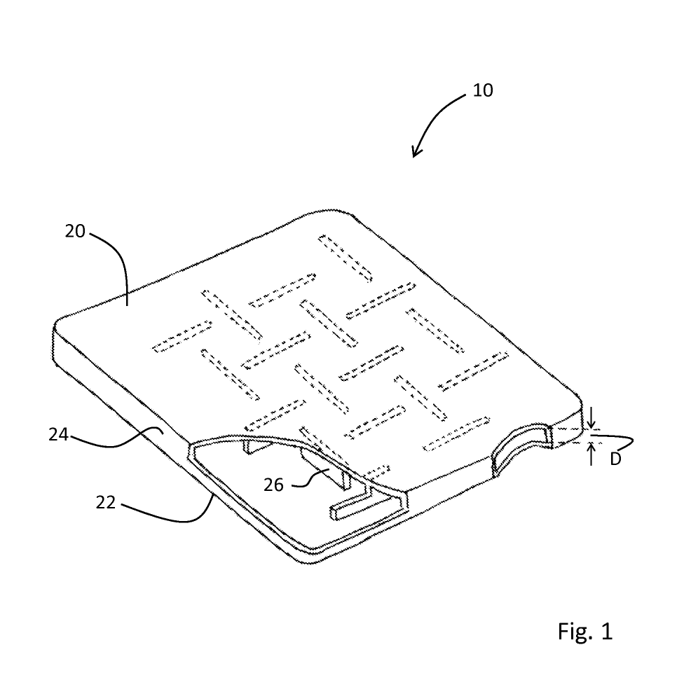

Turning now to FIG. 1, shown is a hollow article 10 having a first wall 20, and a second wall 22. The first and second walls 20, 22 are interconnected by way of a third wall 24 around the periphery of hollow article 10. As such, first wall 20, second wall 22 and third wall 24 form a closed hollow structure. First wall 20 and second wall 22 are substantially planar, and positioned in parallel relationship, generally spaced apart by gap D. Hollow article 10 may be formed in a variety of shapes, depending on the particular application. For example, and as shown in FIG. 1, where hollow article 10 is used in a load floor application, it may be substantially rectangular, with curved corner features. As will be appreciated, the general shape of hollow article 10 is defined by the particular application, and is not intended to be limited to a single configuration.

To provide strength and rigidity to hollow article 10, a plurality of internal structural members are provided. As will be detailed below, each structural member is formed as a protrusion extending from one wall, and is dimensioned to span gap D between the walls such that the structural member engages and becomes integral with the inside surface of the opposing wall. In hollow article 10, the protrusions are formed on both walls, that is both first wall 20 and second wall 22. As such, each structural member provides a fixed internal tack-off attachment between first and second walls 20, 22.

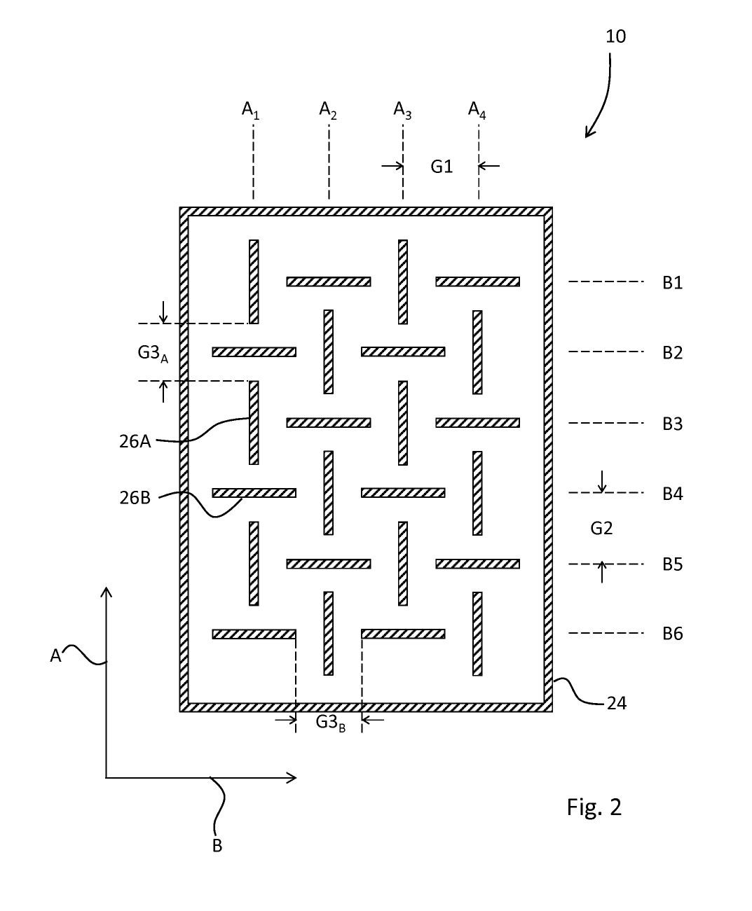

Referring now to FIG. 2, provided is an exemplary hollow article 10 having a first axis A, and a second axis B, where first axis A and second axis B are arranged in perpendicular relationship relative to each other. As can be seen in this embodiment, the plurality of structural members are provided in two orientations. A first grouping of structural members 26A are provided in rows generally parallel to axis A, the rows (identified as A₁, A₂, . . . etc.) separated from each other by gap G1. A second grouping of structural members 26B is provided in rows generally parallel to axis B, the rows (identified as B₁, B₂, . . . etc.) separated from each other by gap G2. Please note that in the following description, structural members 26A, 26B are collectively referred to as structural members 26, where the discussion is applicable to both structural members 26A and structural members 26B. Within each row, the plurality of structural members, for example structural members 26A form a discontinuous rib-like structure with each structural member 26A being in spaced-apart relationship relative to the next. In the first grouping of structural members (aligned with axis A), each structural member 26A is in spaced-apart relationship relative to the next as defined by Gap G3_{A}. In the second grouping of structural members (aligned with axis B), each structural member 26B is in spaced-apart relationship relative to the next as defined by Gap G3_{B}. Gaps G3_{A} and G3_{B} may be the same, or different, depending on the desired arrangement of structural members. In this example, structural members 26 in each row are generally parallel with the axis to which the row is aligned. As such, in the first grouping of structural members, each structural member 26A, for example as present in row A₁, is aligned parallel with axis A. Similarly, in the second grouping of structural members, each structural member 26B, for example as present in row B₁, is aligned parallel with axis B.

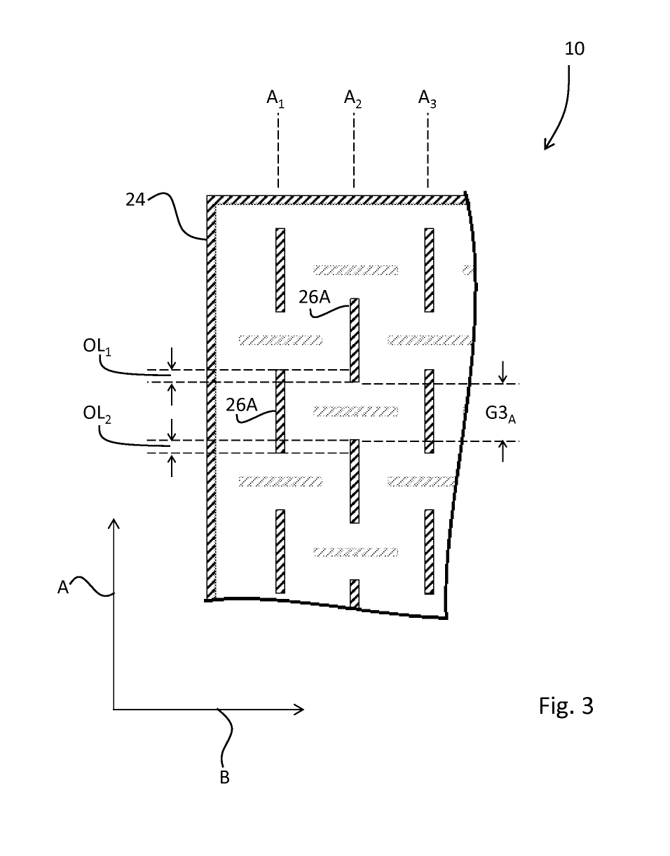

For the rows of structural members 26 formed in each group, adjacent rows are positioned in offset relationship. Having regard to the simplified arrangement shown in FIG. 3, shown are row A₁, row A₂ and row A₃, the rows being arranged in parallel relationship to each other, as well as with reference to axis A. In the aforementioned offset relationship, row A₂ is positioned such that the gap between structural members, that is gap G3_{A} is aligned with structural members 26A in each of the immediately adjacent rows, that is row A₁ and row A₃. As such, and given that gap G3_{A} is dimensioned to be smaller than the length of the structural members, the structural members 26A in each of row A₁ and A₃ span gap G3_{A}, and further extend in overlapping relationship. As shown, the structural members 26A in each of row A₁ and A₃ provide overlap OL₁ and OL₂ with structural members 26A in row A₂ that define gap G3_{A}. As such, any line drawn perpendicular with axis A will pass through one or more structural members. As will be appreciated, and as shown in FIG. 2, while explained above with respect of a first grouping of structural members in relation to axis A, the second grouping of structural members is similarly arranged with the offset relationship, where the rows are generally parallel with axis B. It will be further appreciated that the aforementioned offset arrangement between adjacent rows is a repeating pattern throughout hollow article 10, the extent of which is governed by the number of rows present. It will also be appreciated that depending on the offset positioning between adjacent rows, overlap OL₁ and overlap OL₂ may be the same, or different.

It will also be appreciated that while the length of structural members 26A and structural members 26B are shown to be the same, in some embodiments, the lengths may be different.

Referring back to FIG. 2, the two groupings of structural members 26, that is structural members 26A and structural members 26B are arranged in a cross-cross fashion. In other words, since the first group of structural members 26A is aligned in rows parallel with axis A, and the second group of structural members 26B is aligned in rows parallel with axis B, with axis A and axis B being in perpendicular relationship, the resulting effect is a criss-cross pattern of structural members 26A/26B in hollow article 10. As will be noted, each structural member 26A of the first grouping of structural members is generally located within a respective gap G3_{B} provided between structural members 26B in a given row of the second grouping of structural members 26, and vice versa.

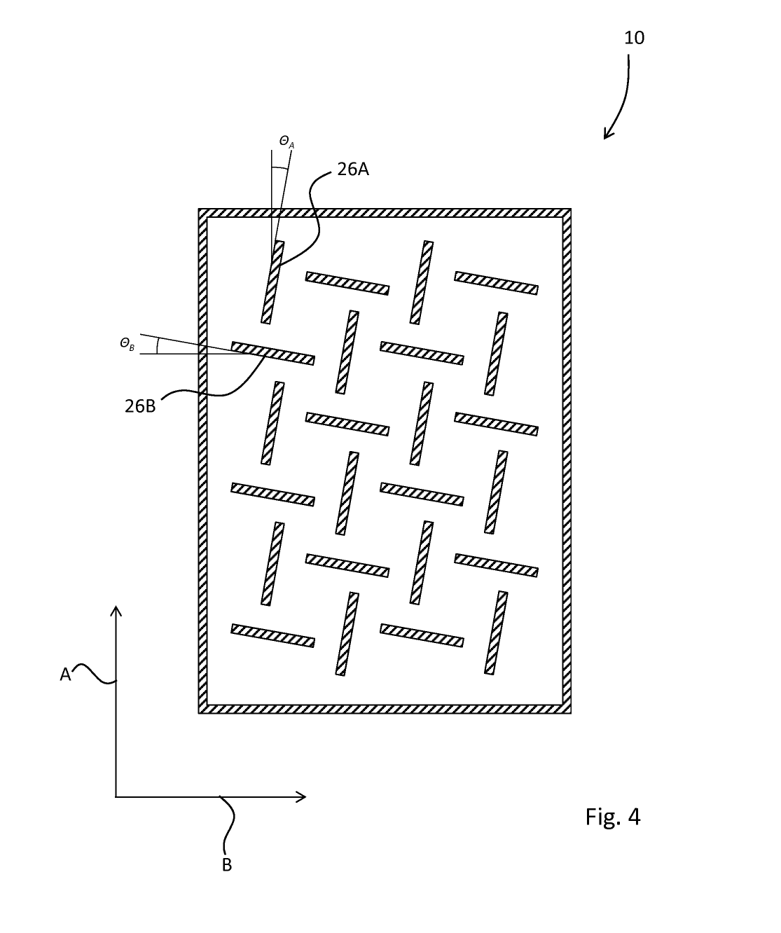

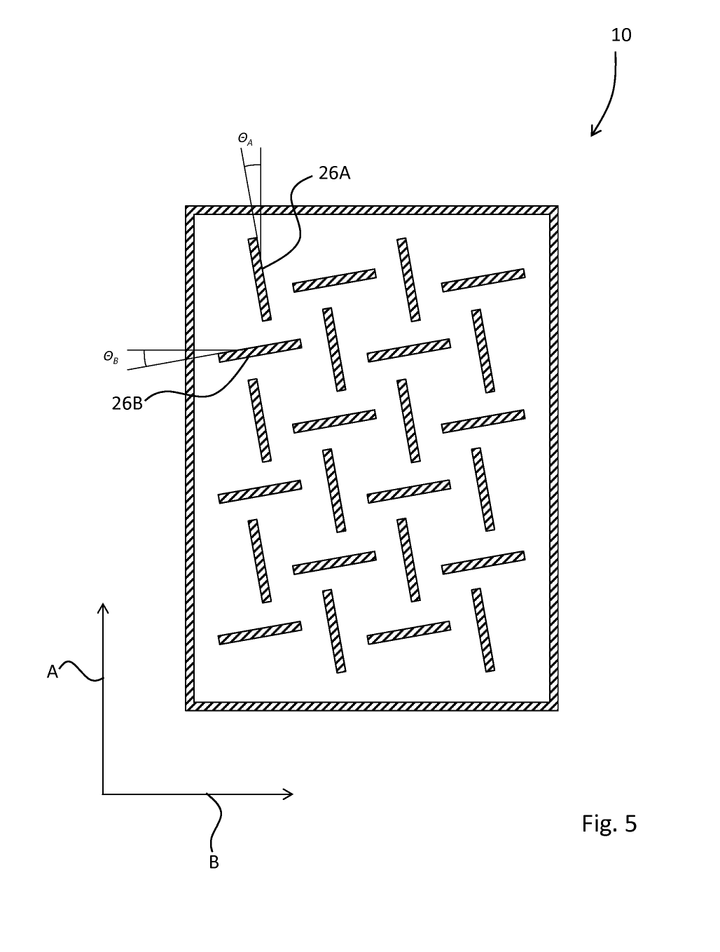

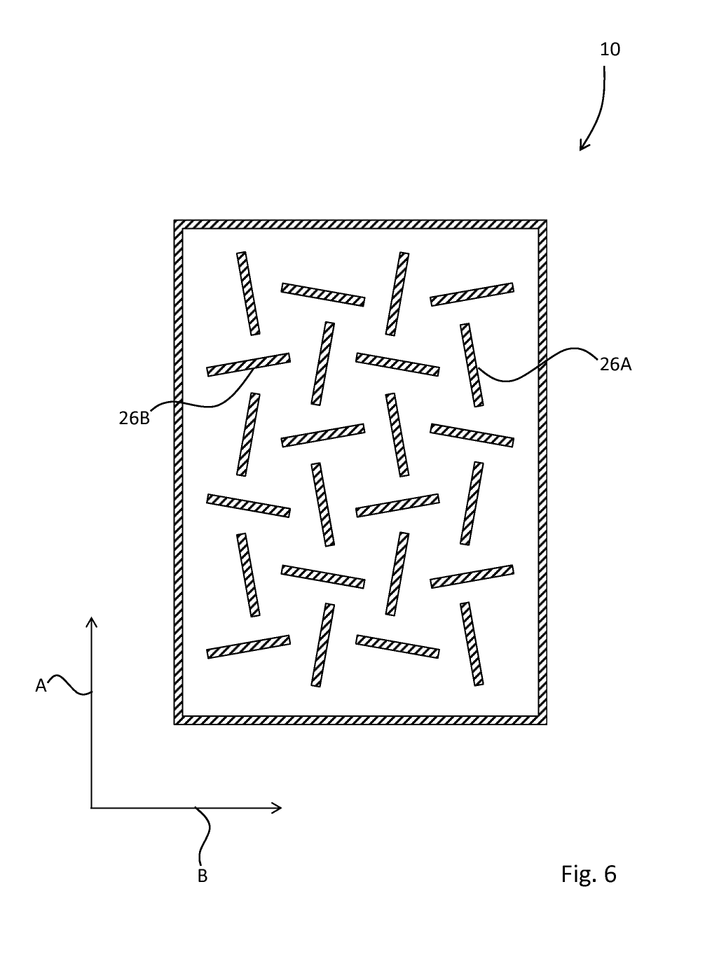

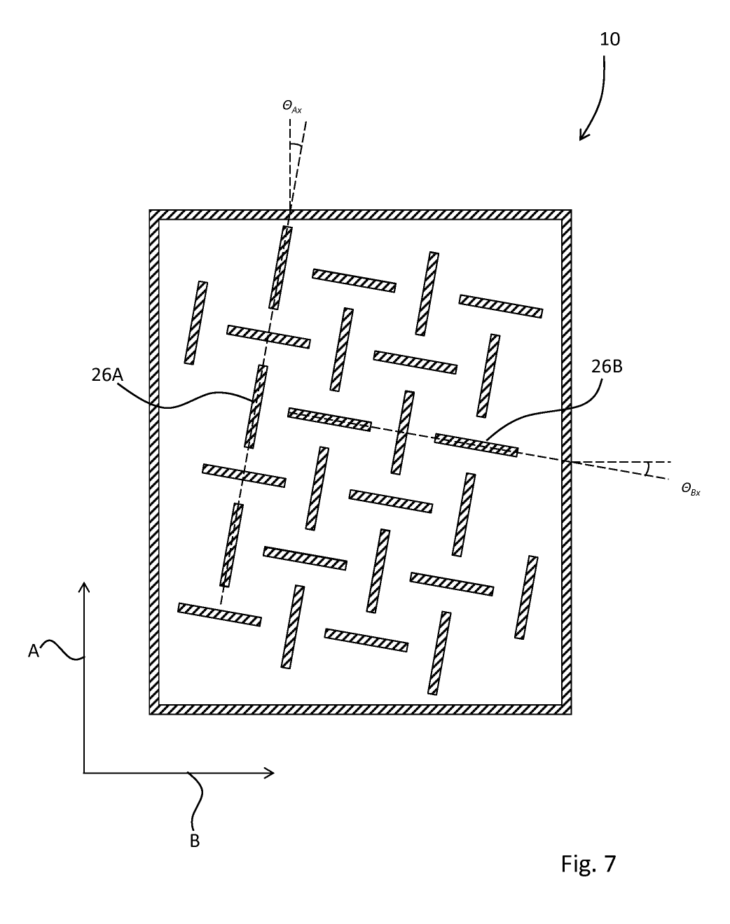

While hollow article 10 detailed above presents structural members 26 in substantially parallel arrangement relative to either of axis A or axis B, it will be appreciated that alternate arrangements are also possible where within the row arrangements provided, each structural member 26 is angularly offset. For example, referring to FIGS. 4 and 5, shown are two alternate arrangements wherein each structural member 26 is angularly offset, with FIG. 4 showing a clockwise rotation, and FIG. 5 showing anticlockwise rotation. In the embodiments shown, the first grouping of structural members 26A are angularly offset (from axis A) by angle Θ_{A}, while the second grouping of structural members 26B are angularly offset (from axis B) by angle Θ_{B}. In some embodiments, angle Θ_{A} may be equivalent to angle Θ_{B}, while in others, the angles are different. As will be appreciated, with each structural member 26 being angularly offset, the extent of overlap between adjacent rows varies. Nevertheless, an overlap between adjacent rows is substantially maintained throughout. In yet another variation, the structural members 26 in each row alternate with respect to being angularly offset, as shown in FIG. 6. It will be appreciated that the rows in which structural members 26 are arranged may be angularly displaced relative to the longitudinal and lateral axes of the structure. For example, having regard to FIG. 7, the first grouping of structural members 26A are aligned in rows parallel to axis Aₓ, where axis Aₓ is angularly offset by angle Θ_{Ax} from axis A. Similarly, the second grouping of structural members 26B are aligned in rows parallel to axis Bₓ, where axis Bₓ is angularly offset by angle Θ_{Bx} from axis B. While angle Θ_{Ax} and angle Θ_{Bx} are shown as being substantially equal, in some embodiments, these angles may be different. Within each grouping, the individual structural members may also be angularly offset, as detailed above with respect to FIGS. 4 through 6. It will be appreciated that the extent of angular offset, that is angle Θ provided to each structural member in a grouping may be varied in the hollow article to provide localized aesthetic and/or strength characteristics. In addition, where a combination of angular offsets requires additional clearance between structural members, the structural members may be sized and spaced accordingly to accommodate the required clearance.

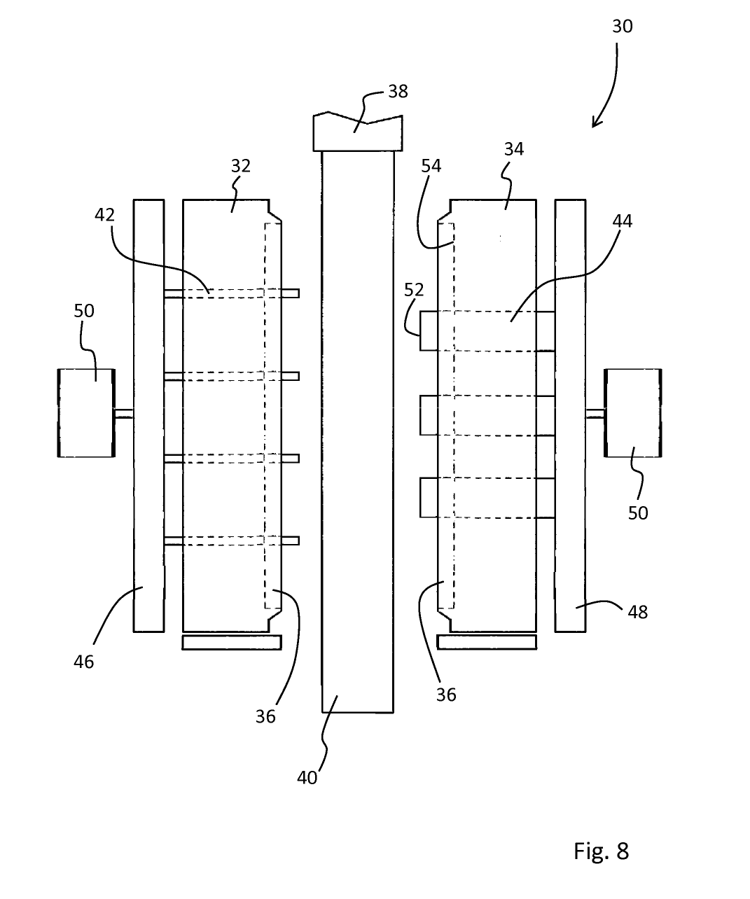

A process for manufacturing the hollow article will now be presented having regard to FIGS. 8 through 13. As shown in FIG. 8, a mold tool 30 for forming a hollow article comprises two mold halves, namely first mold half 32 and second mold half 34 which together in closed configuration define a mold cavity 36 for forming the desired article. Positioned in relation to mold tool 30 is an extruder 38 for delivering a parison 40 to mold tool 30. While an extruder may be positioned in-line relative to mold tool 30, it will be appreciated that a transport means, for example a robot or similar manipulator device, may be provided to transport an extruded parison to mold tool 30. Mold tool 30 may further comprise a parison stretcher (not shown) to manipulate the parison as necessary to during positioning within mold tool 30.

Continuing with FIG. 8, provided in first mold half 32 is a first plurality of slidably displaceable core blades 42 for engaging parison 40 on the side corresponding to first wall 20. Provided in second mold half 34 is a second plurality of slidably displaceable core blades 44 for engaging parison 40 on the side corresponding to second wall 22. The core blades 42, 44 are coupled to respective yoke plates 46, 48, each yoke plate being capable of lateral displacement through the action of one or more actuators 50, permitting the core blades to be protruded and retracted from cavity 36. Core blades 42, 44 engage parison 40 to create corresponding protrusions, where the protrusions become structural members 26 in the finished hollow article. To achieve the aforementioned criss-cross pattern, and as detailed above, for example with respect to FIG. 2, the first plurality of core blades 42 are provided in a first orientation, while the second plurality of core blades 44 are provided in a second orientation. As such, the resulting a hollow article 10 provides a first set of structural members (e.g. structural members 26A) that extend from first wall 20 and engage the inside surface of second wall 22, and a second set of structural members (e.g. structural members 26B) that extend from second wall 22, and engage the inside surface of first wall 20.

As will be appreciated, the stroke provided by the one or more actuators 50 may be adjustable to allow for accurate positioning of core blades 42, 44 relative to the fully extended and fully refracted positions. For example, in the retracted position, end surface 52 of core blades 44 may be partially protruding, flush, or partially recessed from cavity surface 54 to provide for desired finished product surface characteristics. The end surface of core blades 42 may be similarly adjusted. It will be further appreciated that while a single yoke plate may be used to control the plurality of core blades provided for each mold half, multiple yoke plates may be implemented to control ‘banks’ or groupings of core blades. Still further, in some embodiments, each core blade may be controlled by an independent actuator.

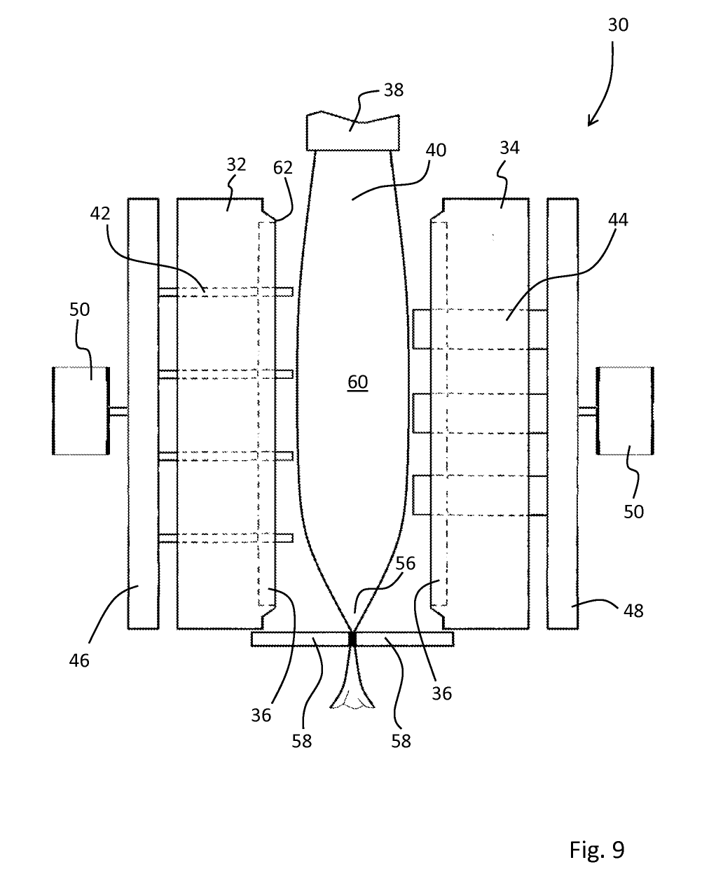

Turning now to FIG. 9, with parison 40 positioned between first and second mold halves 32, 34 of mold tool 30, the bottom end 56 of parison 40 is pinched using pre-seal plates 58. Pinching of bottom end 56 of parison 40 has the effect of forming a closed internal chamber 60, capable of receiving a pressurizing fluid. During mold tool closure 30, parison 40 is subjected to a low pressure pre-blow stage, where parison 40 is partially inflated to urge it into contact with first and second mold halves 32, 34. The pressurized air is generally introduced through one or more blow needles or pins (not shown) provided in extruder head 38, the needles/pins in fluid communication with closed internal chamber 60. In the embodiment shown, core blades 42, 44 are fully extended during closure of mold tool 30.

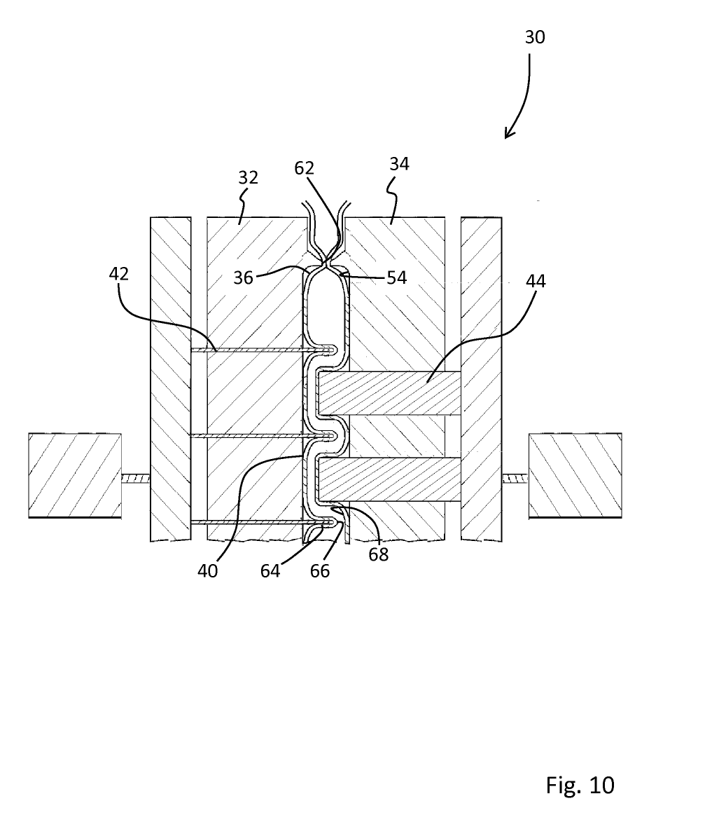

As mold tool 30 continues to close, pre-blown inflated parison 40 contacts each mold half sufficiently to cover the pinch-off 62 defining the outer periphery of the cavity 36 of first and second mold halves 32, 34. At this stage, vacuum applied by way of one or more vacuum ports (not shown) in the cavity of each mold half draws parison 40 over the extended core blades 42, 44, towards cavity surface 54, as shown in FIG. 10. Core blades 42, 44 create localized protrusions 64 in parison 40 from each respective side. For example, with respect to first mold half 32, core blades 42 create protrusions 64 in parison 40, in which the end face 66 of protrusions 64 extend towards the inside surface 68 of the opposing side, situated in second mold half 34.

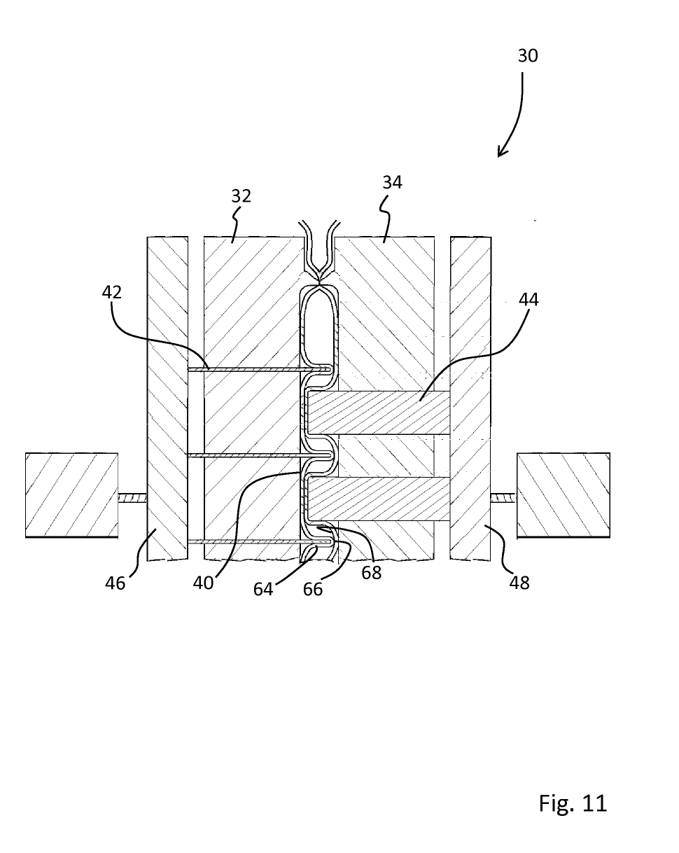

On complete mold tool closure, as seen in FIG. 11, the end face of each protrusion engages and bonds with the inside surface of the opposing wall. For example, in the embodiment shown, on complete mold tool closure, end face 66 of each protrusion 64 formed in first mold half 32 engages and bonds with the inside surface 68 of the opposing wall formed by second mold half 34. Similarly, protrusions formed in parison 40 by core blades 44 extending from second mold half 34 engages and bonds with the inside surface of the opposing wall formed by first mold half 32. Adjustments of the extent of protrusion can be achieved by adjusting the stroke characteristics of yoke plates 46, 48.

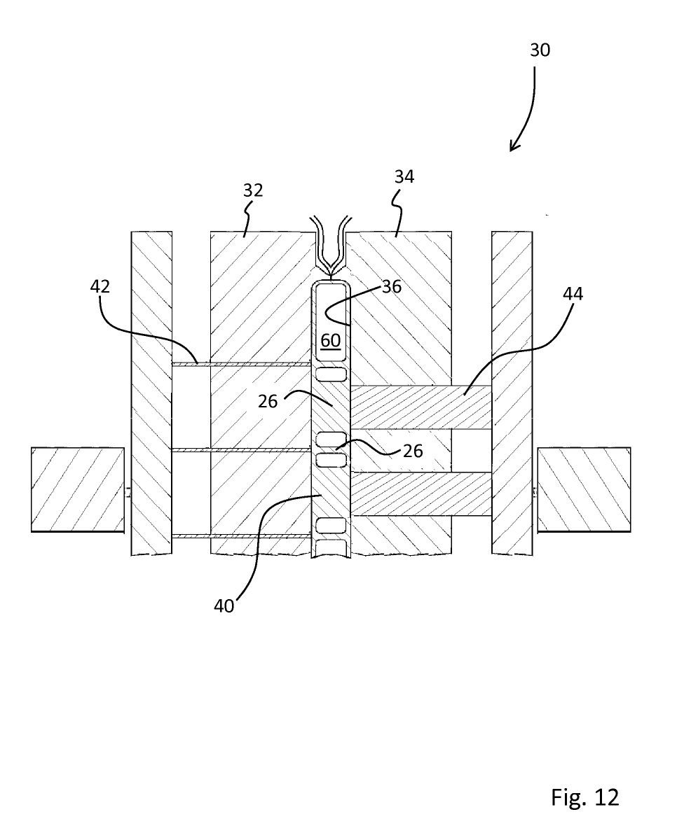

Referring now to FIG. 12, parison 40 is then subject to full blow-molding pressure, causing parison 40 to bear fully against the contour of cavity 36 provided in mold tool 30. Blow molding pressure is typically achieved by way of pressurized gas (e.g. air) introduced through one or more blow needles or pins (not shown) in fluid communication with internal chamber 60 formed within the sealed parison 40. Concurrent with the applied blow molding pressure, core blades 42, 44 are retracted into respective mold halves 32, 34 resulting in the formation of structural members 26 between the first and second walls.

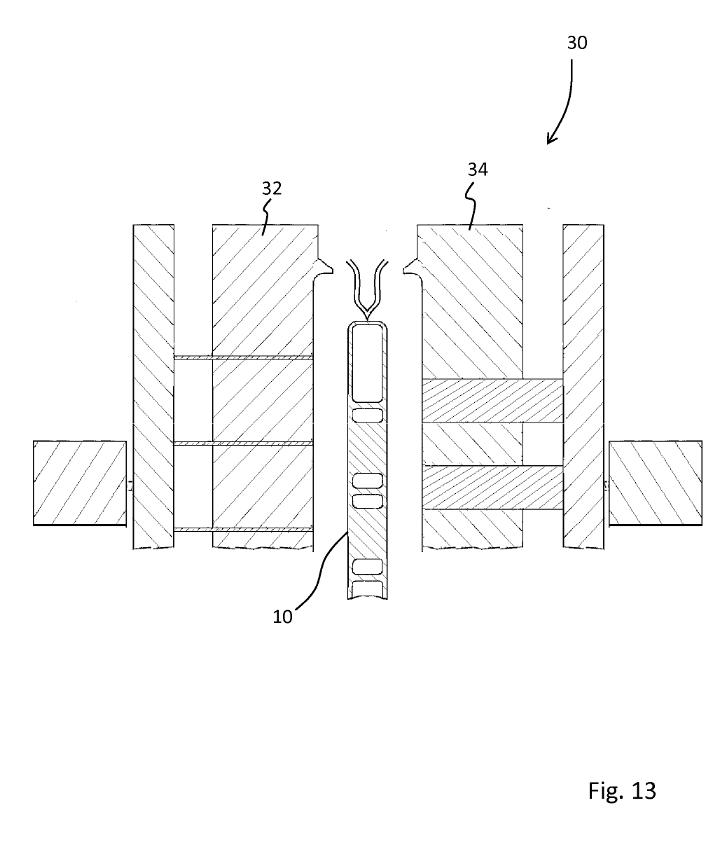

On completion of the blow molding step and sufficient cooling of the resulting article, mold tool 30 is opened and the article is ejected, as shown in FIG. 13. The resulting hollow article 10 is then subjected to any required post-mold processing to remove flashing or other waste material.

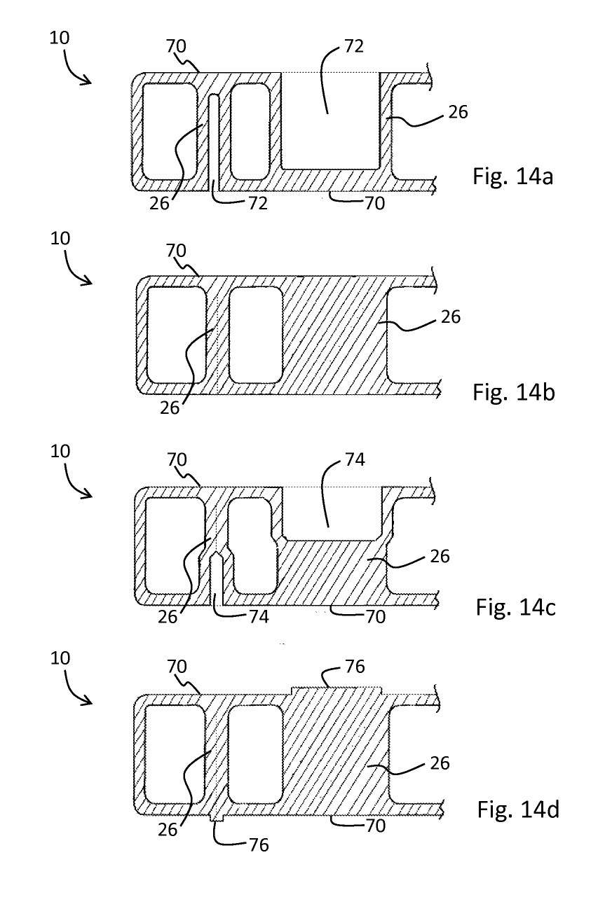

While the embodiment detailed above has core blades 42, 44 fully retracted during blow molding, it will be appreciated that this is merely exemplary, as core blades 42, 44 may also remain fully extended, or positioned at an intermediate point therebetween during the blow molding stage. Accordingly, where core blades 42, 44 are maintained in position within parison 40 on being pressurized, the finished structural member 26 presents on each outside surface 70 as a corresponding hollow core 72, such as that shown in FIG. 14a. Where core blades 42, 44 are removed prior to, or during the introduction of pressurized gas, the walls of protrusion 64 generally collapse together, causing the inside surfaces of protrusion 64 to be integrally bonded. As such, structural member 26 presents a corresponding solid core, such as that shown in 14b, with no substantial surface feature on outside surface 70. Where core blades 42, 44 are partially retracted during pressurization, the finished structural member 26 presents on each outside surface 70 as a hollow indentation 74, such as that shown in FIG. 14c. Where core blades 42, 44 are refracted further than cavity surface 54, a surface extension 76 is presented on each outside surface 70, as seen in FIG. 14d. It will be appreciated that combinations of the above configurations are possible where each side of the hollow article presents a differently formed finished surface. In one non-limiting example, one side may present a finished surface that is flush, as shown in FIG. 14b, while the other side presents a finished surface having a hollow indentation, as shown in FIG. 14c.

While the embodiment detailed above has core blades 42, 44 fully extended during closure of mold tool 30, in some embodiments, core blades 42, 44 are fully retracted during closure of mold tool 30. In other embodiments, core blades 42, 44 are positioned at some intermediate point between, that is only partially extended during closure of mold tool 30. In each case, on complete closure of mold tool 30, core blades 42, 44 are fully extended to effect engagement and bonding between the end face of each protrusion with the inside surface of the opposing wall.

Hollow article 10 is made from a thermoplastic material that has sufficient strength and rigidity to meet the desired performance characteristics. In general, the performance characteristics relate to maximizing the area moment of inertia (MIₐ) about the plate neutral axis (NA), to obtain maximum plate stiffness (S). A non-limiting example of suitable materials includes polypropylene, polyethylene, ABS, ABS/PC, polyamide, PLA and PPS. To meet desired strength and rigidity requirements, the thermoplastic may additionally include a range of inorganic filler components, a non-limiting example of which includes glass, mica, calcium carbonate and talc, and/or organic filler components, a non-limited example of which includes jute, husk, and hemp.

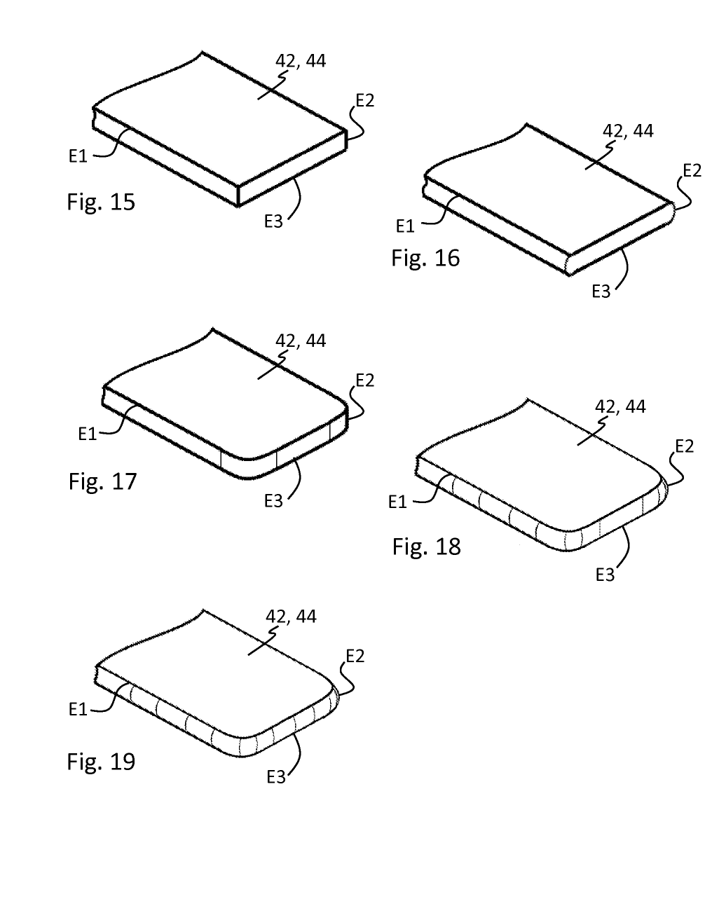

Core blades 42, 44 are generally rectangular shaped plates, designed for slidable displacement in each respective mold half, as described above. In some instances, to facilitate the manufacturing process, the end region of core blades 42, 44 may be configured with a range of shaped features. In a first exemplary configuration, core blades 42, 44 may present as shown in FIG. 15, where edges E1, E2 and E3 are squared. In a second exemplary configuration, core blades 42, 44 may present as shown in FIG. 16, where edge E1 is rounded, while edges E2 and E3 remain squared. In a third exemplary configuration, core blades 42, 44 may present as shown in FIG. 17, where edges E1 and E3 are squared, and edge E2 is rounded. In a forth exemplary configuration, core blades 42, 44 may present as shown in FIG. 18, where each of edges E1, and E2 are rounded, and edge E3 is squared. In a fifth exemplary configuration, core blades 42, 44 may present as shown in FIG. 19, where each of edges E1, E2 and E3 are rounded. As will be appreciated, with respect to edges E1, E2 and E3, any combination of squared vs. rounded may be implemented depending on the desired end product and/or performance characteristics of the materials being used.

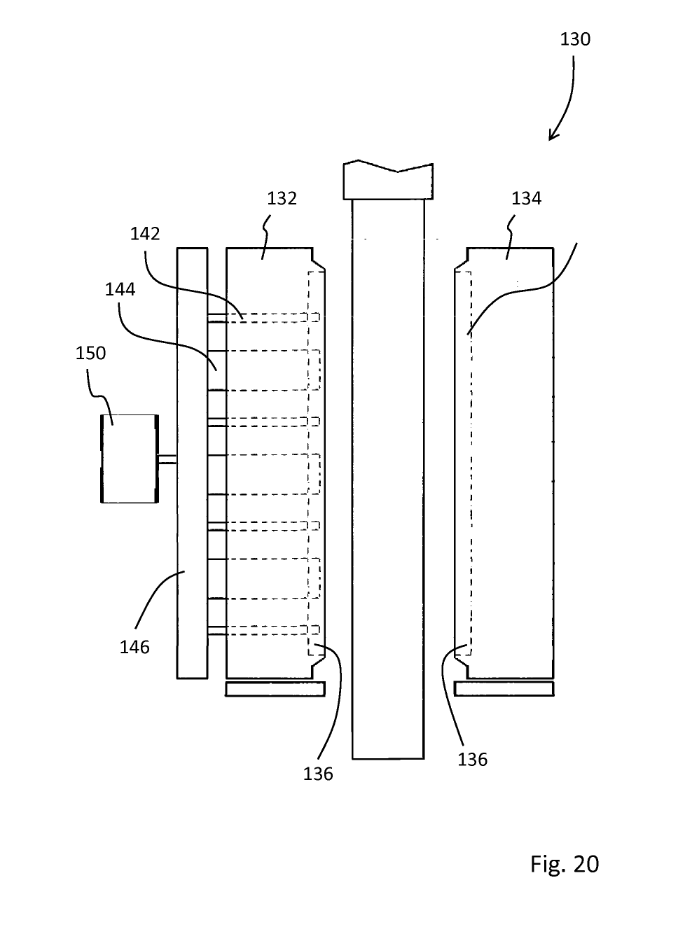

While the process for manufacturing the hollow article has been presented above using mold tool 30 having slidably displaceable blades in both mold halves 32, 34, in another embodiment, the mold tool provides the slidably displaceable blades in only one mold half, for example as shown in FIG. 20. As shown, a mold tool 130 for forming a hollow article comprises two mold halves, namely first mold half 132 and second mold half 134 which together in closed configuration define a mold cavity 136 for forming the desired article. Provided in first mold half 132 is a first plurality of slidably displaceable core blades 142 positioned in a first orientation, and a second plurality of slidably displaceable core blades 144 positioned in a second orientation. The core blades 142, 144 are coupled to yoke plate 146, the yoke plate being capable of lateral displacement through the action of one or more actuators 150, permitting the core blades to be protruded and refracted from cavity 136. The positional relationship of the first and second plurality of core blades 142, 144 within first mold half 132 is set so as to achieve a desired criss-cross pattern, for example any of those detailed in FIGS. 2 through 7.

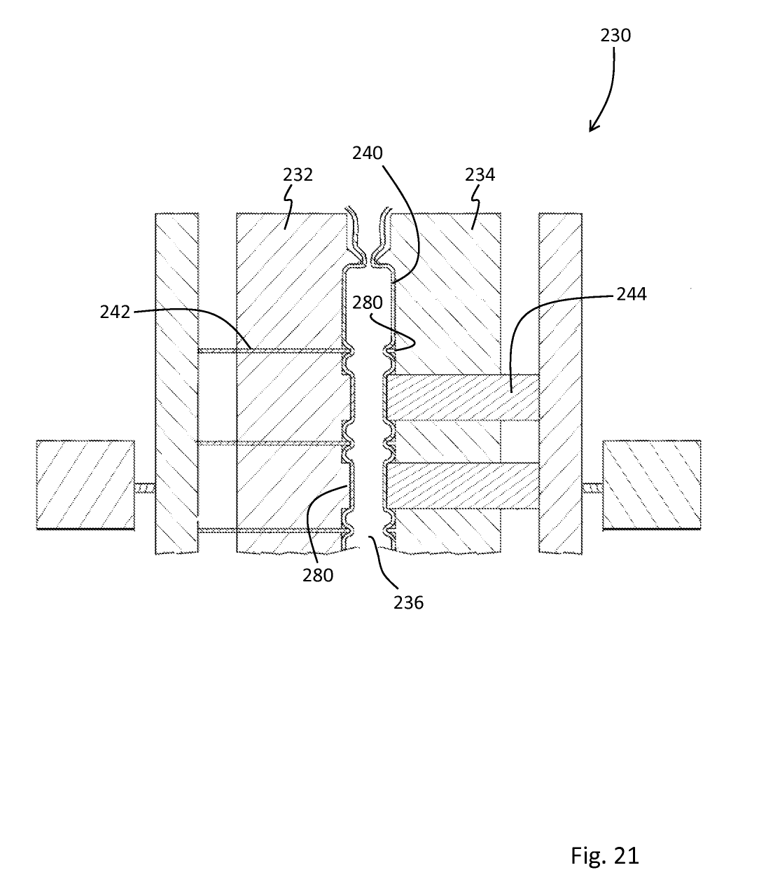

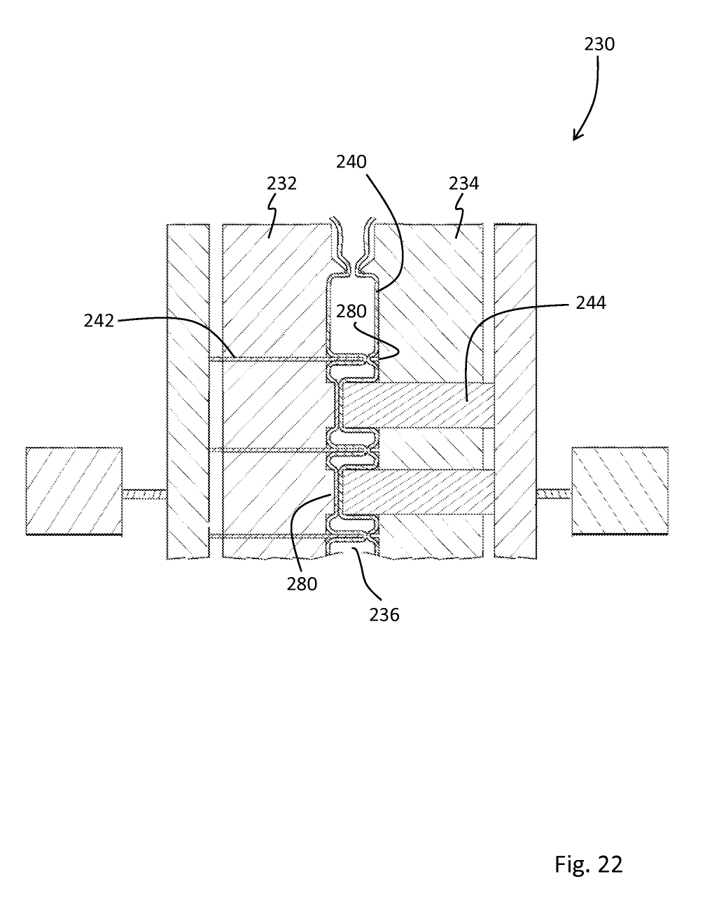

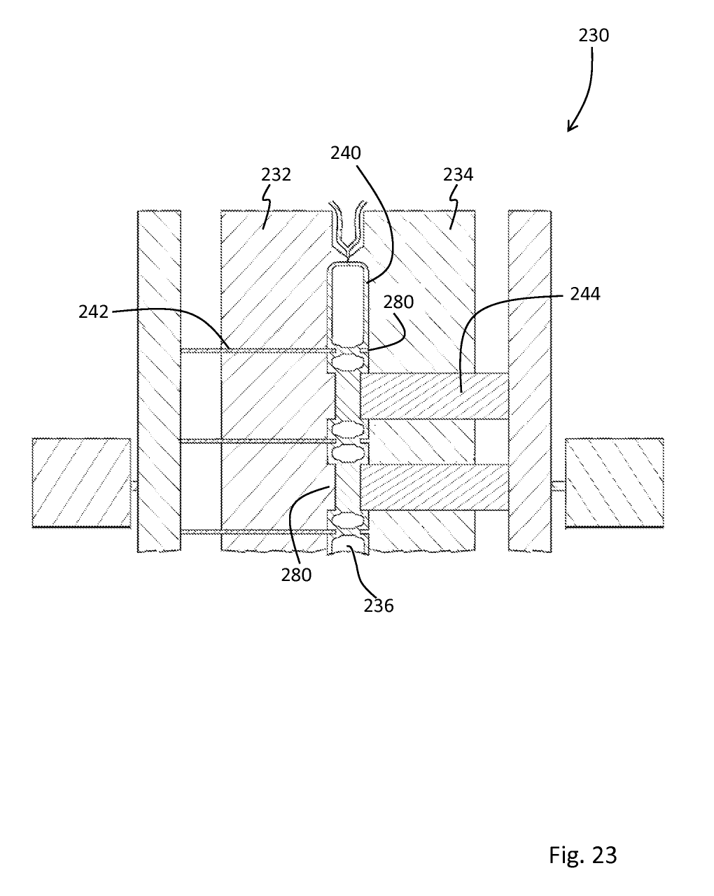

In some embodiments, one or both mold halves, and in particular the mold cavity is provided with mold features to provide additional surface features to the hollow article. For example, having regard to FIGS. 21 through 23, provided is a mold tool 230 in which mold features 280 are provided in each of first mold half 232 and second mold half 234. As the process steps are similar to those detailed above with respect to FIGS. 8 to 13, only the differences are noted here. As shown, mold feature 280 in first mold half 232 corresponds in shape and position with core blades 244 extending from second mold half 234. Similarly, mold feature 280 in second mold half 234 corresponds in shape and position with core blades 242 extending from first mold half 232. As presented, core blades 242, 244 are partially extended during closure of mold tool 230, but it will be appreciated that core blades 242, 244 may be fully extended (as previously described), fully retracted, or partially extended therebetween. Turning now to FIG. 22, the protrusions formed into parison 238 from each core blade 242, 244 engages and bonds to the protrusions formed into parison 238 from each respective mold feature 280. As surface features in the form of a criss-cross pattern are desired in this exemplary embodiment, core blades 242, 244 remain partially protruding from cavity 236, during blow molding, as shown in FIG. 23. It will be appreciated that the mold features provided by mold tool 230 may varied. For example, instead of the mold feature forming a hollow indentation on the outside surface of the hollow article, mold features may be incorporated that result in surface projections, similar to that detailed in FIG. 14c.

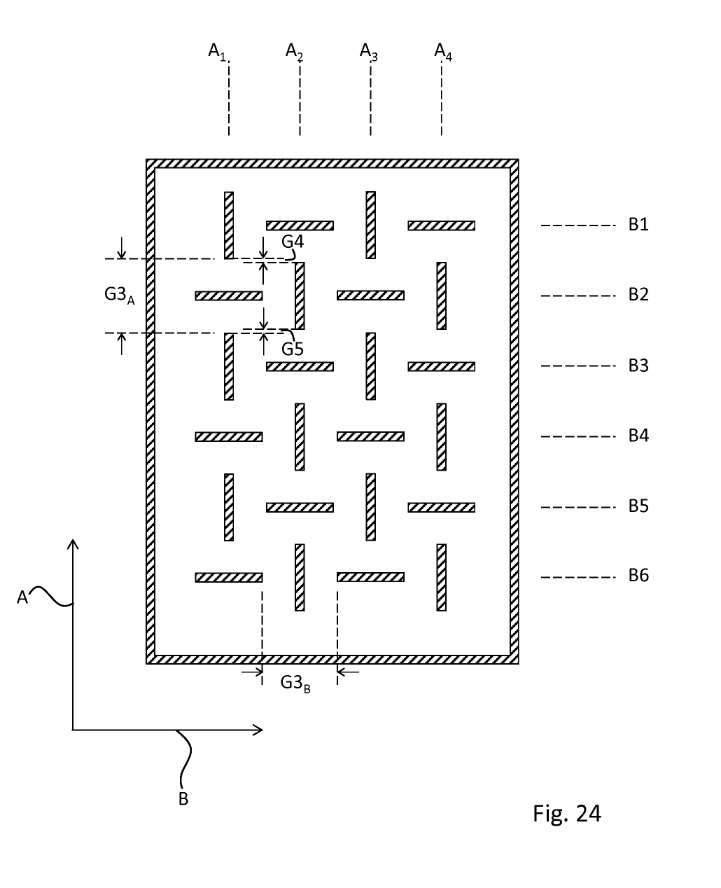

While the hollow articles described above provide an overlap between adjacent structural members, the gap spacing between structural members within a row may be larger than the length of the structural members. For example, having regard to FIG. 24, gap G3_{A} may be dimensioned to be larger than the length of structural members 26A. As such, in the offset arrangement shown, adjacent rows do not extend in overlapping relationship. In the hollow article shown, gaps G3_{A} and G3_{B} are larger than the structural members in the respective rows, leaving for example gaps G4 and G5 in the rows parallel to axis A. Rows in parallel to axis B are similarly arranged. As will be appreciated, variations on the sizing of the gaps is possible, for example where gap G3_{A} is smaller than adjacently aligned structural members 26A, while gap G3_{B} is larger than adjacently aligned structural members 26B. As such, overlap is established with respect to structural members 26A defining rows parallel to axis A, while no overlap is established with respect to structural members 26B defining rows parallel to axis B.

The resulting hollow article provides a criss-cross pattern of structural members, generally in the form of rows provided in two orientations. By virtue of the various criss-cross patterns detailed above, enhanced stiffness is achieved in all directions relative to axes A and B, as compared to prior art structures comprising stiffening ribs oriented in just one direction. As such, the hollow article may be effectively used in situations where potential load forces are difficult to predict, making the technology attractive for a wide range of applications, for example automotive load floors and seat backs.

While the structural members detailed herein have been presented in generally uniform arrangement, that is with a largely constant spacing (e.g. density), the spacing may be varied across the hollow article to create localized areas of increased structural rigidity. In addition, the arrangement of the structural members need not be constant throughout the hollow article. For example, different regions of the hollow article may receive different angular offsets of the structural members and/or the groupings of structural members, to create localized areas of increased structural rigidity. It will also be appreciated that while axis A and axis B have been presented in perpendicular relationship to each other, in some embodiments, the axes may not be perpendicular.

While various embodiments according to the present invention have been described above, it should be understood that they have been presented by way of illustration and example only, and not limitation. It will be apparent to persons skilled in the relevant art that various changes in form and detail can be made therein without departing from the scope of the invention. Thus, the breadth and scope of the present invention should not be limited by any of the above-described exemplary embodiments, but should be defined only in accordance with the appended claims and their equivalents. It will also be understood that each feature of each embodiment discussed herein, and of each reference cited herein, can be used in combination with the features of any other combination. All patents and publications discussed herein are incorporated by reference herein in their entirety.

What is claimed is:

1. A hollow article, comprising:
a first wall;
a second wall, said first and second walls positioned in opposing relationship and defining a space therebetween;
a first set of structural members extending internally from one of said first and second walls, said first set of structural members spanning said space and having an end surface integrally bonded with an inside surface of the opposing wall; and
a second set of structural members extending internally from one of said first and second walls, said second set of structural members spanning said space and having an end surface integrally bonded with an inside surface of the opposing wall,
wherein said first and second sets of structural members are provided in different orientations.

2. The hollow article according to claim 1, wherein said first and second sets of structural members extend from different walls.

3. The hollow article according to claim 1, wherein said first set of structural members extends from said first wall, and said second set of structural members extends from said second wall.

4. The hollow article according to claim 1, wherein said first set of structural members are provided in a plurality of rows generally parallel to a first axis, and wherein said second set of structural members are provided in a plurality of rows generally parallel to a second axis, and wherein within each row, each structural member is arranged in spaced-apart relationship relative to the next as defined by a gap.

5. The hollow article according to claim 4, wherein said first and second axes are arranged in perpendicular relationship to each other.

6. The hollow article according to claim 4, wherein within each row of said first set of structural members, said structural members are aligned parallel with said first axis, and wherein within each row of said second set of structural members, said structural members are aligned parallel with said second axis.

7. The hollow article according to claim 4, wherein adjacent rows of each of said first and second set of structural members are positioned in offset relationship, wherein said gap between adjacent structural members in a row is aligned with said structural members in immediately adjacent rows.

8. The hollow article according to claim 7, wherein said gap is dimensioned to be smaller than said structural members, such that a first overlap is established with respect to a first end of said structural members, and a second overlap is established with respect to a second end of said structural members.

9. The hollow article according to claim 4, wherein each structural member in said first set of structural members is angularly offset from said first axis, and wherein each structural member in said second set of structural members is angularly offset from said second axis.

10. The hollow article according to claim 4, wherein said first and second axes are angularly offset from the longitudinal and lateral axes of the hollow article.

11. A process for producing a hollow article, the process comprising:
positioning a parison between a first mold half and a second mold, said first and second mold halves together defining a cavity for forming said hollow article, said first and second mold halves each having displaceable core blades for forming protrusions in said parison, wherein said first mold half includes a first set of core blades being arranged in a first orientation and said second mold half includes a second set of core blades arranged in a second orientation;
partially inflating said parison through a pre-blow operation;
closing said first and second mold half around said parison;
forming protrusions in said parison with said core blades, said protrusions having an end surface that engages and integrally bonds with an opposing inside surface of said parison to form said structural members;
introducing a pressurized gas into said parison so as to cause said parison to bear against said cavity to form said hollow article; and
opening said first and second mold half, allowing said hollow article formed therein to be released.

12. The process according to claim 11, wherein said core blades are at least partially extended from said respective mold halves into said cavity prior to mold tool closure.

13. The process according to claim 11, wherein said core blades are fully extended prior to complete mold tool closure.

14. The process according to claim 11,further comprising:
applying a vacuum within each mold half to promote movement of said parison towards said cavity for forming the hollow article.

15. A process for producing a hollow article, the process comprising:
positioning a parison between a first mold half and a second mold half, said first and second mold halves together defining a cavity for forming said hollow article, wherein the cavity includes a first set of displaceable core blades for forming protrusions in said parison provided in a first orientation and a second set of displaceable core blades for forming protrusions in said parison provided in a second orientation;
partially inflating said parison through a pre-blow operation;
closing said first and second mold halves around said parison;
forming protrusions in said parison with said first and second sets of core blades, said protrusions having an end surface that engages and integrally bonds with an opposing inside surface of said parison to form said structural members;
introducing a pressurized gas into said parison so as to cause said parison to bear against said cavity to form said hollow article; and
opening said first and second mold halves, allowing said hollow article formed therein to be released.

16. The process according to claim 15, further comprising:
extending said first set of displaceable core blades and said second set of displaceable core blades into said parison from one of the first and second mold halves.

17. The process according to claim 15, further comprising:
extending said first set of displaceable core blades within said parison from the first mold half; and
extending said second set of displaceable core blades into said parison from the second mold half.
